(19) United States
(12) Patent Application Publication
(10) Pub. No.: US 2011/0148222 A1
(43) Pub. Date: Jun. 23, 2011

(54) METHOD FOR DETERMINING A SWITCHING TIME OF AN ELECTRICAL SWITCHING DEVICE

(75) Inventors: Hans-Georg Richter, Berlin (DE); Christian Wallner, Erlangen (DE)

(73) Assignee: SIEMENS AKTIENGESSELLSCHAFT, MUENCHEN (DE)

(21) Appl. No.: 12/992,962

(22) PCT Filed: May 12, 2009
(86) PCT No.: PCT/EP09/55702

§ 371 Date: Jan. 31, 2011

(30) Foreign Application Priority Data
May 16, 2008 (DE) 10 2008 024 420.1

(51) Int. Cl. H02B 1/24

(52) U.S. Cl. 307/115

(57) ABSTRACT

A method determines a switching time of an electric switching device containing an interrupter path disposed between a first line section subjected to a driving voltage and a second line section that forms an oscillating circuit after the switching device undergoes a shut-off step. The method is used for determining the best possible switching time for an electrical switching device to minimize transient voltage surges. It is proposed that either—a temporal progression of a voltage that develops along the interrupter path is determined during a scanning period; or that—a temporal progression of a voltage that develops along the interrupter path is determined during the scanning time.

Method for determining a switching time of an electrical switching device

The invention relates to a method for determining a switching time of an electrical switching device having an interrupter gap which is arranged between a first line section, to which a driving voltage is applied, and a second line section, which forms a resonant circuit after a disconnection process of the switching device.

By way of example, one such method is known from DE 10 2005 005 228 A1 which discloses a method for determining a switching time of an electrical switching device in the form of a gas-insulated switch gear assembly, which connects a first line section. to a generator, which applies a driving voltage to the first line section with a second line section. in the form of an overhead line, and can be disconnected therefrom. In a known manner, an overhead line such as this forms a resonant circuit after the electrical switching device has been disconnected and has been isolated from the first line section with the generator and the driving voltage, wherein, in a known manner, the overhead line has both capacitive and inductive impedances and can be compensated for by means of inductors as variable inductances. When the first line section is connected to the driving voltage, transient overvoltages occur, which can lead to flashovers or other disturbances. Therefore, in order to reduce these transient overvoltages, DE 10 2005 005 228 A1 discloses a method by means of which a switching time for connection of an electrical switching device can be determined, wherein mathematical methods can be used to determine a switching time, which is chosen to be as close as possible to zero crossings of the driving voltage and of an oscillating voltage, which occurs in the resonant circuit of the overhead line, by weighting with different criteria. The method disclosed in DE 10 2005 005 228 A1 for determining the time profiles of the voltages is in this case based on the Prony method described there.

Another known method of the type mentioned initially is based on so-called pattern recognition, in which a switching time of an electrical switching device can be determined from a zero crossing of an envelope of the voltage which occurs across the interrupted path.

The method described in DE 10 2005 005 228 A1 is complex because, in this case, a multiplicity of successive zero crossings of the driving voltage and of the resultant voltage must be considered in relation to one another, and must be weighted with different criteria. The other method, of pattern recognition, does not always lead to the desired result, because the envelope of the voltage which occurs across the interrupter gap is at a frequency which is dependent on the compensation level of the overhead line and therefore on the resonant frequency of the resonant circuit, as a result of which, in the case of a fixed time window, there may be no such zero crossing of the envelope for a changed compensation level in the time window, and it is therefore not possible to determine the best possible switching time.

The object of the present invention is to design a method of the type mentioned initially which makes it possible to determine the best possible switching time for an electrical switching device, in order to minimize transient overvoltages.

According to the invention, this object is achieved in the case of a method of the type mentioned initially in that:
a time profile of a voltage which occurs across the interrupter gap is determined during a sampling time period,
the resonant frequency of the resonant circuit and, from this in turn, a time window are determined from the time profile,
and a switching time is defined in the time window by determining a zero crossing of an envelope, which corresponds to the resonant frequency, of a future profile, calculated on the basis of the time profile, after a defined time period after the disconnection process.

In this case, the method according to the invention has the advantage that the determined time window is determined by the resonant frequency of the resonant circuit which is formed by the overhead line with its capacitive line impedance and the compensation inductors, as a function of the compensation level, thus ensuring that this time window will contain a zero crossing of the envelope of the time profile of the voltage which occurs across the interrupter gap, and an optimum switching time can therefore be determined in the time window, and the switching device and the first line section can be connected to the second line section with the lowest possible transient overvoltages. The defined time period after the disconnection process is in this case determined from general requirements for the switching time, for example, in the case of a high-voltage transmission line this may be a time period of 300 ms, after which, for example, the switching device may be connected again, at the earliest, in the event of a brief interruption.

In another refinement of the method according to the invention, the stated object is achieved in that:
a time profile of a voltage which occurs across the interrupter gap is determined during a sampling time period,
a future profile of the voltage across the interrupter gap, the resonant frequency of the resonant circuit and, from this in turn, a time window are determined from the determined time profile,
and a switching time is defined in the determined time window by determining a zero crossing, which is weighted with criteria of the driving voltage and of the resonant circuit voltage, of the voltage across the interrupter gap after a defined time period after the disconnection process.

The one zero crossing of the voltage, which is weighted with criteria of the driving voltage and resonant circuit voltage, across the interrupter gap is in this case as described in DE 10 2005 005 228 A1 which, with this reference, is part of the present disclosure. Advantageously in this case, in the case of the method according to the invention, the number of profile points to be related to one another in the driving voltage and resonant circuit voltage for zero crossings of the determined voltage across the interrupter gap, and their weighting with respect to one another is limited to the time period determined by the time window, thus considerably reducing the complexity that has to be accepted, because the determined time window is determined by the resonant frequency of the resonant circuit which is formed by the overhead line with its capacitive line impedance and the compensation inductors, as a function of the compensation level, thus ensuring that, in this time window, an optimum switching time can be determined in the time window and the switching device and the first line section can be connected to the second line section with the lowest possible transient overvoltages. The defined time period after the disconnection process is in this case determined from general requirements for the switching time, for example in the case of a high-voltage transmission line this may be a time period of 300 ms, after which, for example, the switching device may be switched on again in the event of a brief interruption.

The invention will be explained in more detail in the following text using the figure and exemplary embodiments, and with reference to the attached figures, in which:

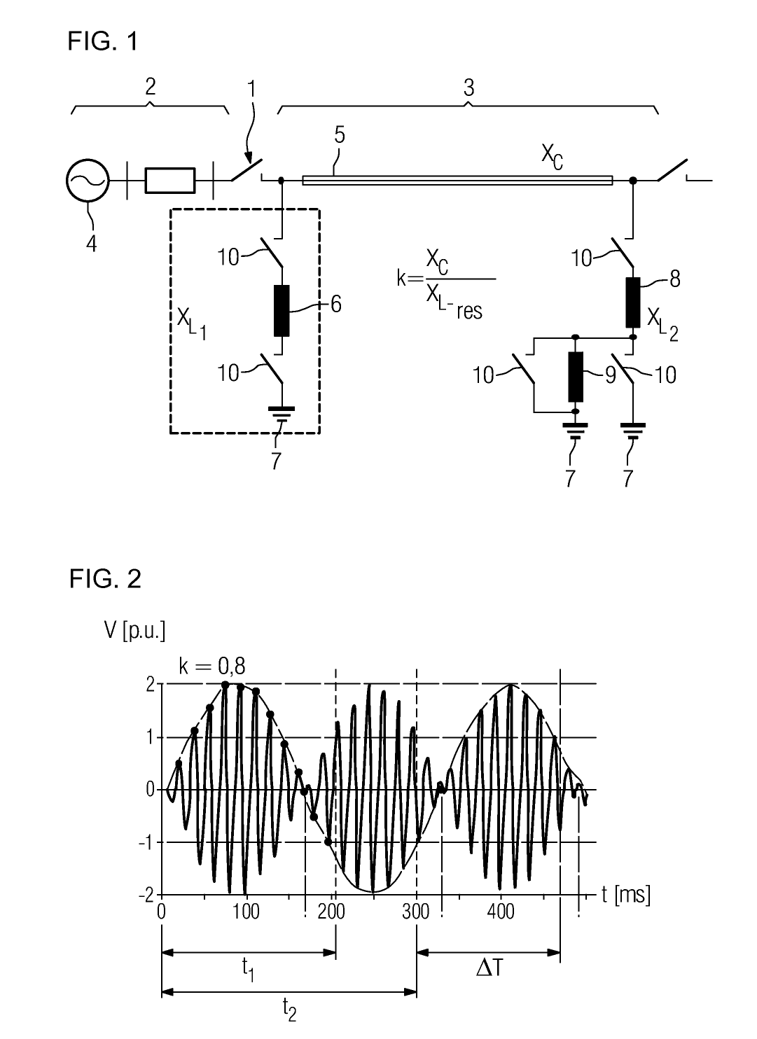

FIG. 1 shows a schematic layout of an electrical power transmission system,

FIG. 2 shows the profile of a resultant voltage, and

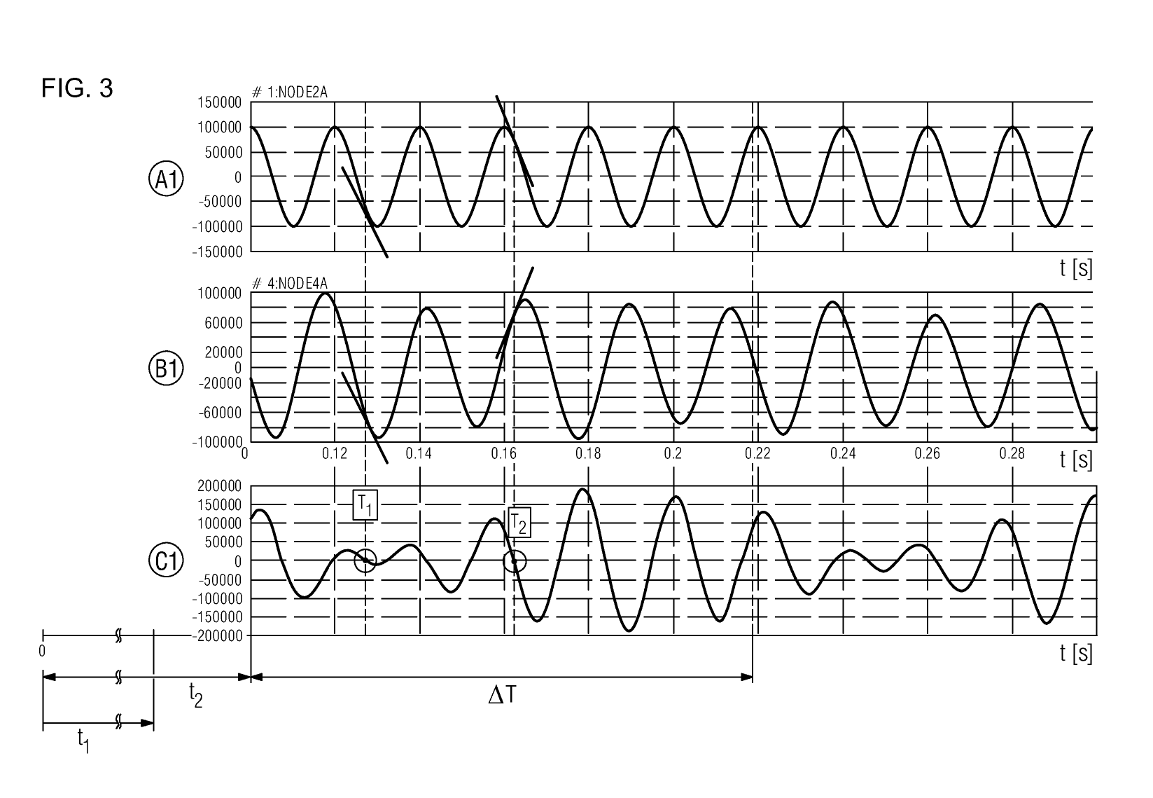

FIG. 3 shows a profile of various voltages.

FIG. 1 shows a basic layout of a line section within an electrical power transmission system. An electrical switching device has an interrupter gap 1 which, for example, is formed from two contact pieces which can move relative to one another. A first line section 2 and a second line section 3 can be connected to one another and disconnected from one another via the interrupter gap 1. The first line section 2 has a generator 4 which produces a driving voltage which, for example, is a 50 Hz AC voltage of a polyphase voltage system. The second line section 3 has an overhead line 5 which can be connected at its first end to a first inductor 6, with respect to ground potential 7, and at its second end via a second inductor 8 to ground potential 7. Furthermore, it is additionally possible for a further inductor 9 to be connected to the second inductor 8. The inductors 6, 8, 9 can be connected in various variants to the ground potential 7 by means of different switching devices 10. It is thus possible to compensate the overhead line 5 to different extents as a function of the load situation, as a result of which the capacitive impedance XC of the overhead line can be overcompensated or undercompensated by means of the inductive impedance XL. A compensation level K can be determined by the ratio of the capacitive impedance XC of the overhead line and the inductive impedance XL of all the inductors. The inductors 6, 8, 9 can be switched differently with respect to one another in order to adjust the compensation level K. However, it is also possible for the inductors to have a variable inductive impedance XL. Plunger-type core inductors can be used, for example, for this purpose.

After the interrupter gap 1 has been opened, a resonant circuit can be formed via the ground potential 7 in the second line section 3. In order to form a resonant circuit in the second line section 3, appropriate current paths must be formed via the switching devices 10 to the ground potential 7. A resonant circuit is formed via the inductive and capacitive impedances, and an oscillating current can flow in the resonant circuit, driven by art oscillating voltage.

By way of example, FIG. 2 shows a resultant voltage profile which is formed across the interrupter gap 1 for a specific compensation level by the inductors 6, 8 and 9. The voltage profile has a multiplicity of voltage zero crossings and exhibits a beat, which is essentially governed by the compensation level of the overhead line and therefore by the resonant frequency of the resonant circuit of the overhead line. After a disconnection process of the switching device 1 of the time t=0, the resultant voltage signal is now sampled during a sampling time period t1, which is greater than, less than or else equal to a time which corresponds to the resonant frequency, and an envelope, which is illustrated by dashed lines, and therefore the resonant frequency of the resonant circuit and the compensation level of the overhead line, are determined from this, in order in turn to determine a time window Δt from this, within which there must be a zero crossing of the envelope of the voltage signal, because its width corresponds to at least one half-cycle of the period of the envelope of the voltage signal. After a disconnection process of the switching device 1, the switching device 1 can once again be connected after a specific time period t2, as the earliest possible connection time, depending on the requirement of the electrical power transmission system, wherein the time frame of the window width Δt for the connection of the switching device 1 is available from the time t2, in which time frame Δt there is at least one zero crossing of the envelope of the voltage signal, at which time the switching device can then be connected with the lowest possible transient overvoltages.

FIG. 3 shows another possible way to determine an optimum switching time for the switching device 1. A1 in this case shows the time profile of the driving voltage for the generator 4 in FIG. 1, B1 shows the time profile of the resultant oscillating voltage on the overhead line 5 of the second line section 3 from FIG. 1, and C1 shows the resultant voltage across the interrupter unit 1, as the difference between the driving voltage A1 and the oscillating voltage B1. The zero crossings of the resultant voltage C1 represent potential switching times, in which case optimum switching times for connection of a switching device can also be found by weighting, by means of the profiles of the driving voltage A1 and the oscillating voltage B1, as already described in DE 10 2005 005 228 A1, which is hereby part of the present disclosure. In this case, in the exemplary embodiment, the voltage profile is determined during a time period t1 after disconnection of the switching device and a time window is determined from this, as already described with reference to FIG. 2, on the basis of the resonant frequency of the resonant circuit and therefore the compensation level of the overhead line, such that, after an earliest possible time period t2, which is governed by the requirements of the electrical power transmission system, the time window Δt which results from the resonant frequency of the resonant circuit is available for a switching time, in which time window Δt zero crossings of the resultant voltage C1 are determined at the times T1 and T2 as possible switching times, with the profiles of the driving voltage A1 and of the oscillating voltage B1 being weighted by mathematical methods as described in DE 10 2005 005 228 A1. For this purpose, the voltage profiles A1, B1 and C1 are considered and related to one another only in the time window Δt.

1-2. (canceled)

3. A method for determining a switching time of an electrical switching device having an interrupter gap disposed between a first line section, to which a driving voltage is applied, and a second line section, which forms a resonant circuit after a disconnection process of the electrical switching device, which comprises the steps of:
determining a time profile of a voltage occurring across the interrupter gap during a sampling time period;
determining a resonant frequency of the resonant circuit from the time profile and, from the resonant frequency determining in turn, a time window; and
defining a switching time in the time window by determining a zero crossing of an envelope, which corresponds to the resonant frequency, of a future profile, calculated on a basis of the time profile, after a defined time period after the disconnection process.

4. A method for determining a switching time of an electrical switching device having an interrupter gap disposed between a first line section, to which a driving voltage is applied, and a second line section, which forms a resonant circuit after a disconnection process of the switching device, which comprises the steps of:
determining a time profile of a voltage occurring across the interrupter gap during a sampling time period;
determining a future profile of the voltage across the interrupter gap, a resonant frequency of the resonant circuit and, from this in turn, a time window from the time profile determined; and
defining a switching time in the time window determined by determining a zero crossing, which is weighted with criteria of the driving voltage and of a resonant circuit voltage, of the voltage across the interrupter gap after a defined time period after the disconnection process.
